(19) United States
(12) Patent Application Publication
(10) Pub. No.: US 2026/0095093 A1
(43) Pub. Date: Apr. 2, 2026

(54) STEP-DOWN AND PHASE-SHIFTING TRANSFORMER AND OPERATIONAL CONTROL METHOD THEREOF

(71) Applicants: STATE GRID JIANGSU ELECTRIC POWER CO., LTD. RESEARCH INSTITUTE, Nanjing (CN); BAODING TIANWEI BAOBIAN ELECTRIC CO., LTD., Baoding (CN); NR ELECTRIC CO., LTD., Nanjing (CN)

(72) Inventors: Qun LI, Nanjing (CN); Jinjiao LIN, Nanjing (CN); Lei GAO, Nanjing (CN); Ningyu ZHANG, Nanjing (CN); Peng LI, Nanjing (CN); Shi CHEN, Nanjing (CN); Liangliang SONG, Nanjing (CN); Tonglei WANG, Nanjing (CN); Yunlong DONG, Nanjing (CN); Cheng LI, Baoding (CN); Fengfeng DING, Nanjing (CN); Dong ZHANG, Baoding (CN); Jing CHEN, Nanjing (CN)

(21) Appl. No.: 18/949,990

(22) Filed: Nov. 16, 2024

Related U.S. Application Data
(63) Continuation of application No. PCT/CN2024/125034, filed on Oct. 15, 2024.

(30) Foreign Application Priority Data
Sep. 30, 2024 (CN) 202411383145.4

(51) Int. Cl. H02M 3/04; H02M 1/00

(52) U.S. Cl. CPC H02M 3/04; H02M 1/0043

(57) ABSTRACT

Disclosed are a step-down and phase-shifting transformer and an operational control method thereof. The step-down and phase-shifting transformer is connected to grids on at least two sides and at least includes a first winding, a second winding, and a third winding. The third winding is provided with a tap-position adjustment switch, the third winding is magnetically coupled to the first winding and the second winding, and the third winding is electrically connected to the first winding or the second winding, such that phase angle control and transmission power control between grids on different sides can be realized by adjusting the tap-position adjustment switch on the basis of voltage transformation.

This is a continuation of International Patent Application No. PCT/CN2024/125034, filed Oct. 15, 2024, which claims priority to Chinese Patent Application No. 202411383145.4 filed to China National Intellectual Property Administration on Sep. 30, 2024, the disclosures of both of which are incorporated herein by reference in their entireties.

### TECHNICAL FIELD

The present application relates to the field of power systems and automation thereof, for example, relates to a step-down and phase-shifting transformer and an operational control method thereof.

### BACKGROUND

The large-scale integration of new energy sources and diverse new types of loads leads to transmission bottlenecks in some key lines/main transformers, and the power flow exhibits an increasingly random characteristic. Flexible power flow control devices are an important support for facilitating the access and consumption of new energy sources, and are an effective means of power flow optimization control in an energy internet. At present, the flexible power flow control devices, such as unified power flow controllers, phase shifters, and distributed power flow controllers, are mainly applied to line power flow control, while conventional transformers do not have power flow control functions.

Under the development trend of a new power system, with a large amount of fluctuating energy sources and loads being connected, some transforms are subjected to reverse power flow or overload conditions. Additionally, demands for interconnection of power grids at different voltage levels and mutual power support are increasing. Therefore, it is necessary to overcome the technology of step-down and phase-shifting transformers.

### SUMMARY

Embodiments of the present application provide a step-down and phase-shifting transformer and an operational control method thereof, which integrates a step-down function with a phase-shifting function. Compared with conventional transformers, the step-down and phase-shifting transformer has a function of power flow control at a port; and compared with a manner of adopting a transformer and a phase shifter which is separately disposed in an output line of the phase shifter, the step-down and phase-shifting transformer can save land area and investment.

In a first aspect, an embodiment provides a step-down and phase-shifting transformer. The step-down and phase-shifting transformer is at least connected to grids of two sides, and the step-down and phase-shifting transformer at least includes:
a first winding, a second winding, and a third winding, where the first winding, the second winding and the third winding each adopts a three-phase winding; and
the third winding serves as a phase modulation winding and is provided with a tap-position adjustment switch, the third winding is magnetically coupled to the first winding and the second winding, the third winding is electrically connected to the first winding or the second winding, and a phase difference between a voltage of the third winding and a terminal voltage of the first winding or the second winding is 90° or close to 90°, such that on the basis of voltage transformation, phase angle control and transmission power control between grids on different sides can be realized by adjusting the tap-position adjustment switch.

In a second aspect, an embodiment provides an operational control method of a step-down and phase-shifting transformer, which is applied to the step-down and phase-shifting transformer stated in any of the examples of the present application, and the method includes:
performing closed-loop control on the step-down and phase-shifting transformer to make the step-down and phase-shifting transformer be connected to grids on at least two sides;
adjusting a tap position of the tap-position adjustment switch according to a target power and a current power at a port of the step-down and phase-shifting transformer, as well as a current tap position of the tap-position adjustment switch of the step-down and phase-shifting transformer until the current power at the port of the step-down and phase-shifting transformer after adjustment reaches the target power; or
selecting key nodes in the grids on the two sides to which the step-down and phase-shifting transformer is connected, and controlling load rate differences among the key nodes to be less than a setting threshold for load rate difference.

The embodiments of the present application provide a step-down and phase-shifting transformer and an operational control method thereof. The step-down and phase-shifting transformer is connected to grids on at least two sides. The step-down and phase-shifting transformer at least includes: a first winding, a second winding, and a third winding. The first winding, the second winding and the third winding each adopts a three-phase winding. The third winding serves as a phase modulation winding and is provided with a tap-position adjustment switch, the third winding is magnetically coupled to the first winding and the second winding, and the third winding is electrically connected to the first winding or the second winding. A phase difference between a voltage of the third winding and a terminal voltage of the first winding or the second winding is 90° or close to 90°, such that on the basis of voltage transformation, phase angle control and transmission power control between grids on different sides can be realized by adjusting the tap-position adjustment switch. The above technical solutions integrate a step-down function with a phase-shifting function. The step-down and phase-shifting transformer adopts a three-phase three-winding structure, one of the windings serves as a phase modulation winding and is provided with a tap-position adjustment switch. Thus, the step-down and phase-shifting transformer has the functions of phase angle shift and transmission power flow control. By connecting two or more power grids with different voltage levels, the step-down and phase-shifting transformer can achieve flexible control of an output power flow of the transformer. Therefore, the above solutions can be adapted to various application scenarios, such as interconnection and mutual support of power grids with different voltage levels, and power regulation between power grids connected by a hub substation. Compared with conventional transformers, the above solutions can realize the transmission power flow control; and compared with the traditional method of separate arrangement of a transformer and a phase shifter, the above solutions can save land area and investment.

### BRIEF DESCRIPTION OF THE DRAWINGS

FIG. 1 is a schematic structural diagram of a step-down and phase-shifting transformer according to an embodiment one of the present application.

FIG. 2 is a schematic diagram of a first topological structure of a step-down and phase-shifting transformer according to an embodiment one of the present application.

FIG. 3 is a schematic diagram of voltage vectors of windings of a step-down and phase-shifting transformer in a first topological structure according to an embodiment one of the present application.

FIG. 4 is a schematic diagram of a phase A adjustment of a step-down and phase-shifting transformer in a first topological structure according to an embodiment one of the present application.

FIG. 5 is a schematic diagram of a second topological structure of a step-down and phase-shifting transformer according to an embodiment one of the present application.

FIG. 6 is a schematic diagram of voltage vectors of windings of a step-down and phase-shifting transformer in a second topological structure according to an embodiment one of the present application.

FIG. 7 is a schematic diagram of a phase A adjustment of a step-down and phase-shifting transformer in a second topological structure according to an embodiment one of the present application.

FIG. 8 is a schematic diagram of a third topological structure of a step-down and phase-shifting transformer according to an embodiment one of the present application.

FIG. 9 is a schematic diagram of voltage vectors of windings of a step-down and phase-shifting transformer in a third topological structure according to an embodiment one of the present application.

FIG. 10 is a schematic diagram of a phase A adjustment of a step-down and phase-shifting transformer in a third topological structure according to an embodiment one of the present application.

FIG. 11 is a flow chart of an operational control method of a step-down and phase-shifting transformer according to an embodiment two of the present application.

FIG. 12 is a schematic diagram of a step-down and phase-shifting transformer that adopts a first topological structure is connected to power grids according to an embodiment two of the present application.

FIG. 13 is a schematic diagram of a step-down and phase-shifting transformer that adopts a second topological structure is connected to power grids according to an embodiment two of the present application.

FIG. 14 is a schematic diagram of a step-down and phase-shifting transformer that adopts a third topological structure is connected to power grids according to an embodiment two of the present application.

FIG. 15 is a flow chart of an operational control method of a step-down and phase-shifting transformer according to an embodiment three of the present application.

FIG. 16 is another flow chart of an operational control method of a step-down and phase-shifting transformer according to an embodiment three of the present application.

FIG. 17 is a diagram of simulation effects of a step-down and phase-shifting transformer that adopts a first topological structure to realize step-down and phase-shifting for interconnection with 10 kV and 20 kV power grids.

FIG. 18 is a diagram of simulation effects of a step-down and phase-shifting transformer that adopts a second topological structure to realize step-down and phase-shifting for interconnection with 220 kV and 110 kV power grids.

FIG. 19 is a diagram of simulation effects of a step-down and phase-shifting transformer that adopts a third topological structure to realize step-down and phase-shifting for interconnection with 110 kV and 35 kV power grids.

### DETAILED DESCRIPTIONS

It should be noted that the terms “first”, “second”, etc. used in the specification, claims, and description of accompanying drawings of the present application are for distinguishing similar objects, and are not necessarily used to describe a specific order or sequence. Data used in such a way can be interchangeable where appropriate, so that the embodiments of the present application described herein to be implemented in orders other than those illustrated or described herein. In addition, the terms “including/comprising” and “having”, as well as any other variations, are intended to cover non-exclusive inclusions. For example, a process, method, system, product, or device that includes a series of steps or units is not necessarily limited to those steps or units clearly listed, but may also include other steps or units that are not clearly listed or are inherent to these processes, methods, products, or devices.

### Embodiment One

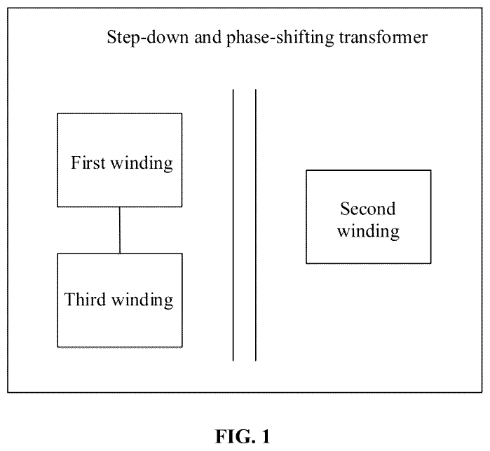

FIG. 1 is a schematic structural diagram of a step-down and phase-shifting transformer provided in the embodiment one of the present application, and the step-down and phase-shifting transformer can be applied to voltage transformation and phase angle control for power grids at different voltage levels. As shown in FIG. 1, the step-down and phase-shifting transformer provided in the embodiment one is connected to at least two side grids. The step-down and phase-shifting transformer includes a first winding, a second winding, and a third winding. The first winding, the second winding and the third winding each adopts a three-phase winding. The third winding serves as a phase modulation winding and is provided with a tap-position adjustment switch, the third winding is magnetically coupled to the first winding and the second winding, and the third winding is electrically connected to the first winding or the second winding. A phase difference between a voltage of the third winding and a terminal voltage of the first winding or the second winding is 90° or close to 90°, such that except voltage transformation, phase angle control and transmission power control between different grid sides can be realized by adjusting the tap-position adjustment switch.

FIG. 1 illustrates the situation that the third winding is electrically connected to the first winding, and the third winding is magnetically coupled to the first winding and the second winding. For the situation that the third winding is electrically connected to the second winding, and the third winding is magnetically coupled to the first winding and the second winding, structural principles are similar to those of FIG. 1 and will not be described herein.

In this embodiment, in order to achieve a step-down and phase-shifting transformer integrated with voltage transformation and phase angle control functions, the third winding is introduced as the phase modulation winding. The third winding can be electrically connected to the first winding or the second winding, such that the voltage of the third winding acts on the terminal voltage of the first winding or the second winding to which the third winding is connected. For the situation that the third winding is electrically connected to the first winding, it is necessary to ensure that a phase difference of each phase between the third winding and the connected first winding is 90° or close to 90°, and the third winding is magnetically coupled to the first winding and the second winding, such that on the basis of voltage transformation, phase angle control and transmission power control between different grid sides can be realized by adjusting the tap-position adjustment switch. For the situation that the third winding is electrically connected to the second winding, it is necessary to ensure that a phase difference of each phase between the third winding and the connected second winding is 90° or close to 90°, and the third winding is magnetically coupled to the first winding and the second winding, such that on the basis of voltage transformation phase angle control and transmission power control between different grid sides can be realized by adjusting the tap-position adjustment switch.

In an embodiment, the third winding is provided with a polarity reversing switch to realize an adjustment of a phase angle in a phase leading direction or a phase lagging direction.

The above description specifies the step-down and phase-shifting transformer having three windings. In addition, the step-down and phase-shifting transformer can also have four windings, which are assigned as high, medium and low voltage levels, and an introduced phase modulation winding. In addition to performing a phase angle control on a high-voltage grid side or a low-voltage grid side, the phase angle control can be also performed on a medium-voltage grid side. It can be considered that the step-down and phase-shifting transformer provided in this embodiment can implement phase angle control and transmission power flow control at different voltage levels between the high-voltage side grid and the low-voltage side grid, or the high-voltage side grid and the medium-voltage side grid, or the medium-voltage side grid or the low-voltage side grid.

In the above solution, the step-down and phase-shifting transformer, which has functions of voltage transformation and phase shifting, is configured to connect one or more of the high-voltage side grids and the low-voltage side grids, achieving voltage transformation and phase angle shift simultaneously. By connecting two or more power grids with different voltage levels, it realizes flexible control of an output power flow of the transformer. Therefore, the above solution can be adapted to various application scenarios, such as interconnection and mutual support of power grids with different voltage levels, and power regulation between power grids connected by a hub substation. Compared with the conventional transformers, the above solutions can achieve the transmission power flow control; and compared with the traditional method of separate arrangement of a transformer and a phase shifter, the above solutions can save land area and investment Therefore, it is an effective control means for new energy consumption in a new-type power system and power flow optimization control in an energy internet.

In this embodiment, the step-down and phase-shifting transformer mainly has three topological structures, which are respectively designated as a first topological structure, a second topological structure, and a third topological structure. As one alternative embodiment of the embodiments of the present application, it could be described on the basis of the above embodiment that the first topological structure is adopted for the step-down and phase-shifting transformer, the first winding is connected to the high-voltage side grid and the second winding is connected to the low-voltage side grid to achieve voltage transformation and phase angle adjustment between the high-voltage side grid and the low-voltage side grid. The described structure is as follows.

Based on an hour number of the first winding and the third winding, an input terminal of a phase A of the first winding is connected in series with a phase B of the third winding or a phase C of the third winding; based on the hour number of the first winding and the third winding, an input terminal of a phase B of the first winding is connected in series with the phase C of the third winding or a phase A of the third winding; and based on the hour number of the first winding and the third winding, an input terminal of a phase C of the first winding is connected in series with the phase A of the third winding or the phase B of the third winding. When the hour number between the first winding and the third winding is 11 o'clock, the former of the third winding is connected in series; and when the hour number between the first winding and the third winding is 1 o'clock, the latter of the third winding is connected in series. The step-down and phase-shifting transformer realizes voltage transformation through the first winding and the second winding, and realizes phase angle difference adjustment and power control between a high voltage level grid and a low voltage level grid through a tap-position adjustment of the third winding.

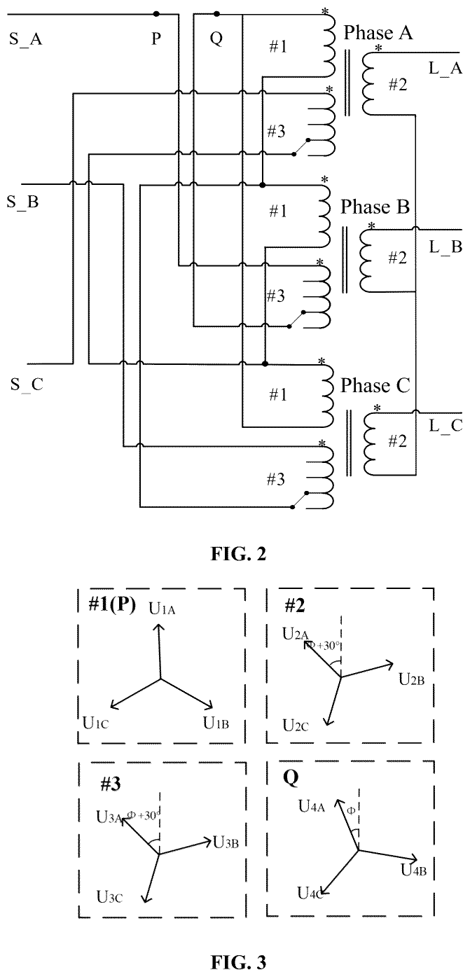

FIG. 2 is a schematic diagram of the first topological structure of the step-down and phase-shifting transformer according to the embodiment one of the present application. As shown in FIG. 2, the first topological structure of the step-down and phase-shifting transformer includes a first winding (designated as #1 in the figure), a second winding (designated as #2 in the figure) and a third winding (designated as #3 in the figure), where the first winding and the second winding are connected to the high voltage level grid and the low voltage level grid, respectively, and positions of S terminals and L terminals of incoming/outgoing line ports are shown in FIG. 2. In the first topological structure, the first winding adopts a delta connection, the second winding adopts a star connection. The hour number between the first winding and the third winding is 11 o'clock. The third winding is the phase modulation winding and is provided with the tap-position adjustment switch. The input terminal of the phase A of the first winding is connected in series with the phase B of the third winding, and the input terminal of the phase B of the first winding is connected in series with the phase C of the third winding; and the input terminal of the phase C of the first winding is connected in series with the phase A of the third winding.

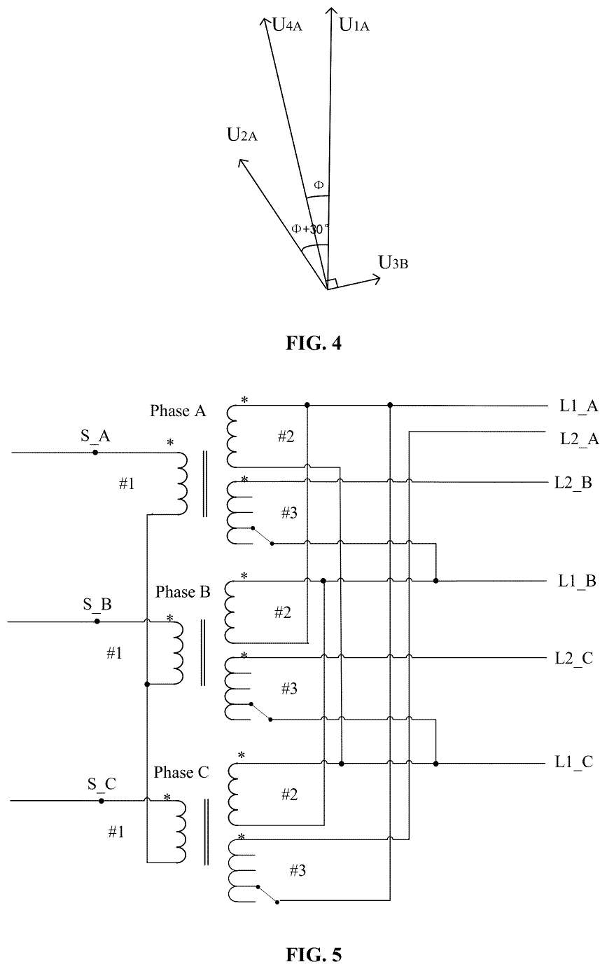

FIG. 3 is a voltage vector diagram of each of windings in a first topological structure of a step-down and phase-shifting transformer according to the embodiment one of the present application. FIG. 4 is a schematic diagram of a phase-A adjustment in a first topological structure of a step-down and phase-shifting transformer according to the embodiment one of the present application. As shown in FIG. 3, three-phase voltage vectors at points P and Q (the points P and Q are two designated positions) at a port of the first winding (designated as #1 in the figure) are respectively represented as U_{1A}, U_{1B}, U_{1C}, U_{4A}, U_{4B}, and U_{4C}, three-phase voltage vectors at a port of the second winding (designated as #2 in the figure) are respectively represented as U_{2A}, U_{2B}, U_{2C}, and three-phase winding voltage vectors at a port of the third winding (designated as #3 in the figure) are respectively represented as U_{3A}, U_{3B}, U_{3C}. As shown in FIG. 4, Φ represents a phase-shifting angle of the step-down and phase-shifting transformer. Taking a principle of the phase-A adjustment as an example, a phase angle between a voltage vector U_{3B} of the phase B of the third winding and the voltage vector U_{4A} at the point Q of the port of the first winding is 90° (a phase angle between the voltage vector U_{3B} of the phase B of the third winding and the voltage vector U_{1A} at the point P of the port of the first winding is 90°−Φ). Thus, when a winding voltage of the phase B of the third winding is connected in series at the port of the phase A of the first winding, a voltage phase (Φ) between the point P and the point Q at the port of the first winding is adjusted by determining a transformation ratio of the third winding and adjusting the tap position, thereby realizing a phase-shifting angle (Φ) between the point P at the port of the first winding and the port of the second winding and controlling phase angle difference and transmission power between the high-voltage side grid and the low-voltage side grid.

As an alternative embodiment of the embodiments of the present application, it could be described based on the above embodiment that the second topological structure is adopted for the step-down and phase-shifting transformer. The first winding is connected to the high-voltage side grid and the second winding is connected to two low-voltage side grids, such that the step-down and phase-shifting transformer can realize voltage transformation on the high-voltage side and one of the two low-voltage sides and realize voltage transformation and phase angle control on the high-voltage side and the other low-voltage side. This topology is applicable to a substation having a plurality of transformers, the step-down and phase-shifting transformer, via a non-phase-shifting busbar, can be operated in parallel with other transformers of the substation for a long period of time or can perform short-term load transfer without power outage, and the step-down and phase-shifting transformer can be interconnected and power-controlled with a low-voltage grid on the opposite side. The described structure is as follows.

The first winding is connected to the high-voltage side grid, and the second winding has two outgoing lines, where a first outgoing line is connected to a non-phase-shifting low-voltage side grid, and a second outgoing line is connected to a phase-shifting low-voltage side grid via the third winding. Based on an hour number of the second winding and the third winding, a second outgoing line of the phase A of the second winding is connected in series with the phase C of the third winding or the phase B of the third winding; based on the hour number of the second winding and the third winding, a second outgoing line of the phase B of the second winding is connected in series with the phase A of the third winding or the phase C of the third winding; and based on the hour number of the second winding and the third winding, a second outgoing line of the phase C of the second winding is connected in series with the phase B of the third winding or the phase A of the third winding. When the hour number between the second winding and the third winding is 11 o'clock, the former of the third winding is connected in series; and when the hour number is 1 o'clock, the latter of the third winding is connected in series. The step-down and phase-shifting transformer can achieve voltage transformation via the first winding and the second winding, and phase angle difference adjustment and power control between the high voltage level grid and the low voltage level grid at the second outgoing line through a tap-position adjustment of the third winding.

FIG. 5 is a schematic diagram of the second topological structure of the step-down and phase-shifting transformer according to the embodiment one of the present application. As shown in FIG. 5, the second topological structure of the step-down and phase-shifting transformer includes a first winding (designated as #1 in the figure), a second winding (designated as #2 in the figure) and a third winding (designated as #3 in the figure), and positions of terminals S, L1 and L2 of the incoming and outgoing line ports are shown in FIG. 5. The first winding is connected to a high voltage level grid. The second winding has two outgoing lines, L1 and L2, one of the outgoing lines is connected to a non-phase-shifting busbar on the low-voltage side, and the other outgoing line is connected to a phase-shifting busbar via the third winding. The first winding adopts the star connection, and the second winding adopts the delta connection. When the hour number between the second winding and the third winding is 11 o'clock, and the third winding is the phase modulation winding and is provided with a tap switch, an output terminal of a phase A of the second winding is connected in series with a phase C of the third winding, an output terminal of a phase B of the second winding is connected in series with a phase A of the third winding, and an output terminal of a phase C of the second winding is connected in series with a phase B of the third winding.

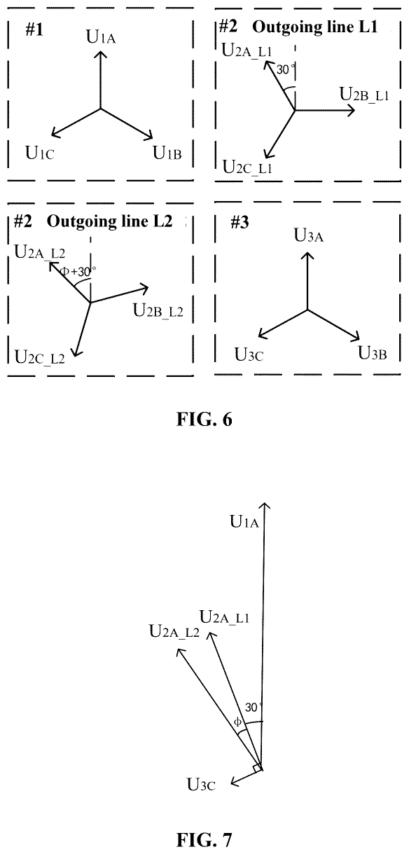

FIG. 6 is a voltage vector diagram of each of the windings in the second topological structure of the step-down and phase-shifting transformer according to the embodiment one of the present application. FIG. 7 is a schematic diagram of a phase-A adjustment in the second topological structure of the step-down and phase-shifting transformer according to the embodiment one of the present application. As shown in FIG. 6, three-phase voltage vectors at a port of the first winding (designated as #1 in the figure) are respectively represented as U_{1A}, U_{1B} and U_{1C}, three-phase voltage vectors at a port of an outgoing line L1 of the second winding (designated as #2 in the figure) are respectively represented as U_{2A_L1}, U_{2B_L1} and U_{2C_L1}, three-phase voltage vectors at a port of an outgoing line L2 of the second winding are respectively represented as U_{2A_L2}, U_{2B_L2} and U_{2C_L2}, and three-phase voltage vectors of a winding of the third winding (designated as #3 in the figure) are respectively represented as U_{3A}, U_{3B}, U_{3C}. U_{1A} is a voltage of the phase A on the high-voltage side (winding #1), U_{2A_L1} and U_{2A_L2} are voltages of the phase A on the low-voltage side (winding #2), and U_{3C} is a winding voltage of the phase modulation winding #3. As shown in FIG. 7, Φ represents a phase difference between the voltage of the phase A at the outgoing line L1 on the low-voltage side (winding #2) and the voltage of the phase A at the outgoing line L2 on the low-voltage side (winding #2). Taking principles of the phase-A adjustment as an example, a phase angle between a voltage U_{3C} of the phase C of the third winding and a voltage U_{2A_L1} at the port L1 of the second winding is 90°, and the port L1 of the phase A of the second winding is connected in series with a winding voltage of the phase C of the third winding, thus a voltage phase (Φ) between the port L1 and the port L2 of the second winding is adjusted by determining a transformation ratio of the third winding and adjusting a tap position, thereby realizing a phase-shifting angle (Φ) between the port S of the first winding and the port L2 of the second winding and controlling phase angle difference and transmission power between the high-voltage side grid and the low-voltage side grid.

As an alternative embodiment of the embodiments of the present application, description can be made based on the above embodiment. When the step-down and phase-shifting transformer adopts the third topological structure, the first winding has two outgoing lines that are respectively connected to two high-voltage side grids, and the second winding is connected to a low-voltage side grid. The step-down and phase-shifting transformer can realize power flow control or phase angle control between the two high-voltage sides, and also realize voltage transformation between the high-voltage sides and the low-voltage side. The topology is applicable to application scenarios where power interconnection and mutual support are required for high-voltage side grids. The described structure is as follows.

Based on an hour number of the first winding and the third winding, an input terminal of a phase A of the first winding is connected in series with a phase C of the third winding or a phase B of the third winding; based on the hour number of the first winding and the third winding, an input terminal of a phase B of the first winding is connected in series with the phase A of the third winding or the phase C of the third winding; and based on the hour number of the first winding and the third winding, an input terminal of a phase C of the first winding is connected in series with the phase B of the third winding or the phase A of the third winding. When the hour number between the first winding and the third winding is 1 o'clock, a former of the third winding is connected in series; and when the hour number is 11 o'clock, the latter of the third winding is connected in series. The step-down and phase-shifting transformer achieves voltage transformation through the first winding and the second winding, and achieves phase angle difference adjustment and power control between the two high voltage level grids through a tap-position adjustment of the third winding.

FIG. 8 is a schematic diagram of the third topological structure of the step-down and phase-shifting transformer according to the embodiment one of the present application. As shown in FIG. 8, the third topological structure of the step-down and phase-shifting transformer includes a first winding (designated as #1 in the figure), a second winding (designated as #2 in the figure) and a third winding (designated as #3 in the figure). As shown in FIG. 8, the transformer is a three-phase three-winding structure as a whole. The first winding adopts the delta connection and is provided with two outgoing lines, that is, S1 and S2, which are respectively connected to a high-voltage side grid 1 and a high-voltage side grid 2. The second winding also adopts the delta connection and is connected to a low-voltage side grid. The hour number between the first winding and the third winding is 1 o'clock, the third winding serves as a phase modulation winding and is provided with a tap-position adjustment switch. The input terminal of the phase A of the first winding is connected in series with the phase C of the third winding, the input terminal of the phase B of the first winding is connected in series with the phase A of the third winding; and the input terminal of the phase C of the first winding is connected in series with the phase B of the third winding.

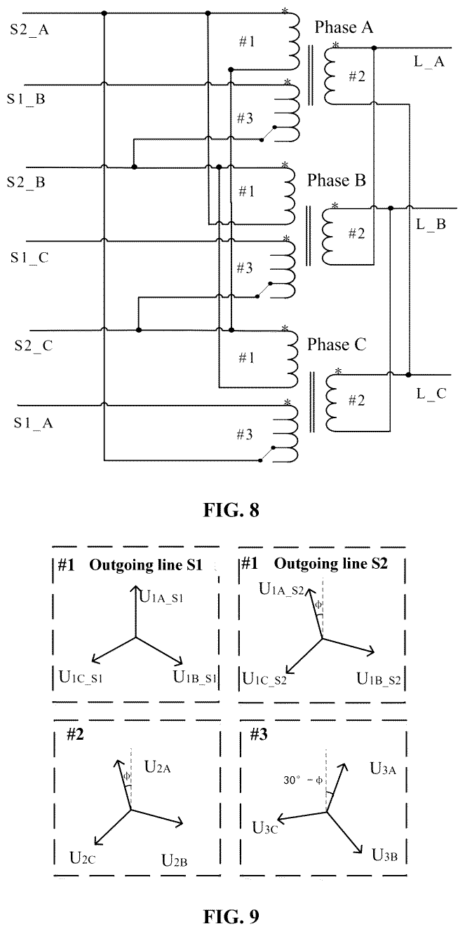

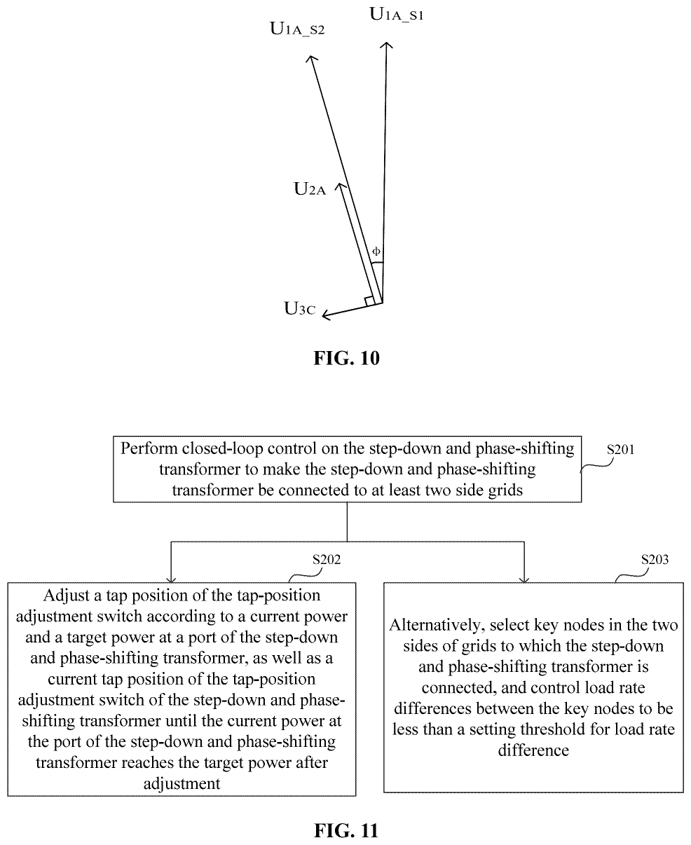

FIG. 9 is a voltage vector diagram of each of the windings in the third topological structure of the step-down and phase-shifting transformer according to the embodiment one of the present application. FIG. 10 is a schematic diagram of a phase-A adjustment in the third topological structure of the step-down and phase-shifting transformer according to the embodiment one of the present application. As shown in FIG. 9, three-phase voltage vectors of an outgoing line S1 of the first winding (designated as #1 in the figure) are respectively represented as U_{1A_S1}, U_{1B_S1} and U_{1C_S1}, three-phase voltage vectors of an outgoing line S2 of the first winding are respectively represented as U_{1A_S2}, U_{1B_S2} and U_{1C_S2}, three-phase voltage vectors of the second winding (designated as #2 in the figure) are respectively represented as U_{2A}, U_{2B} and U_{2C}, and three-phase voltage vectors of the third winding (designated as #3 in the figure) are respectively represented as U_{3A}, U_{3B} and U_{3C}. As shown in FIG. 10, Φ represents a phase angle difference between the two high-voltage side grids of the phase A. Taking principles of the phase-A adjustment as an example, the voltage U_{3C} of the phase C of the third winding is 90° relative to the voltage U_{1A_S2} at the port S2 of the phase A of the first winding (the voltage U_{3C} of the phase C of the third winding is 90°−Φ relative to the voltage U_{1A_S1} at the port S1 of the phase A of the first winding). Thus, when an input terminal of a phase A of the first winding is connected in series with a winding voltage of the phase C of the third winding, a voltage phase (Φ) between the port S1 and the port S2 of the first winding is adjusted by determining a transformation ratio of the third winding and adjusting the tap position of the third winding, thereby realizing a phase-shifting angle (Φ) between the port S1 and the port S2 of the first winding and controlling the phase angle difference and transmission power between the two high-voltage side grids.

The above technical solutions specify the specific implementation manners of the three topological structures of the step-down and phase-shifting transformer.

### Embodiment Two

FIG. 11 is a flow chart of an operational control method of a step-down and phase-shifting transformer provided in embodiment two of the present application, and the method can be applied to scenarios of step-down transformation and phase angle control of grids with different voltage levels.

As shown in FIG. 11, the embodiment two provides the operational control method of the step-down and phase-shifting transformer, and the method specifically includes the following steps.

In S201, closed-loop control is performed on the step-down and phase-shifting transformer to make the step-down and phase-shifting transformer be connected to at least two side grids.

In this embodiment, control modes of the step-down and phase-shifting transformer include closed-loop control, port power control, and balancing control. This step is used for performing the closed-loop control on the step-down and phase-shifting transformer to make the step-down and phase-shifting transformer be connected to grids at at least two sides, and the closed-loop control is associated with a topological structure of the step-down and phase-shifting transformer.

Illustratively, when adopting the first topological structure, the step-down and phase-shifting transformer is connected to the high-voltage side grid via a first circuit breaker, and is connected to the low-voltage side grid via a second circuit breaker. The step of performing the closed-loop control on the step-down and phase-shifting transformer to make the step-down and phase-shifting transformer be connected to grids can be described as: controlling the first circuit breaker to close, such that the step-down and phase-shifting transformer is charged; detecting a phase angle difference between both sides of the second circuit breaker; when the phase angle difference is greater than a setting threshold for phase angle difference, the tap-position adjustment switch is adjusted and the step of detecting the phase angle difference between both sides of the second circuit breaker is performed again until the phase angle difference is less than or equal to the setting threshold for phase angle difference; and controlling the second circuit breaker to close to make the step-down and phase-shifting transformer be connected to the grids.

Illustratively, when adopting the second topological structure, the step-down and phase-shifting transformer is connected to the high-voltage side grid via a third circuit breaker, is connected to one low-voltage side grid via a fourth circuit breaker, and is connected to the other low-voltage side grid via a fifth circuit breaker and a second isolating switch in sequence; and the other low-voltage side grid is connected to a first isolating switch and the fourth circuit breaker. The step of performing the closed-loop control on the step-down and phase-shifting transformer to make the step-down and phase-shifting transformer be connected to the grids can be described as: controlling the third circuit breaker to close, such that the step-down and phase-shifting transformer is charged; controlling the fourth circuit breaker to close to supply power to the low-voltage side grid; controlling the second isolating switch to close and the first isolating switch to open; detecting a phase angle difference between both sides of the fifth circuit breaker; when the phase angle difference is greater than a setting threshold for phase angle difference, the tap-position adjustment switch is adjusted, the step of detecting the phase angle difference between both sides of the fifth circuit breaker is performed again until the phase angle difference is less than or equal to the setting threshold for phase angle difference; and controlling the fifth circuit breaker to close to make the step-down and phase-shifting transformer be connected to the grids.

Illustratively, when adopting the third topological structure, the step-down and phase-shifting transformer is connected to a high-voltage side grid via a sixth circuit breaker, is connected to the other high-voltage side grid via a seventh circuit breaker, and is connected to a low-voltage side grid via an eighth circuit breaker. The step of performing the closed-loop control on the step-down and phase-shifting transformer to make the step-down and phase-shifting transformer be connected to the grids can be described as: controlling the seventh circuit breaker to close, such that the step-down and phase-shifting transformer is charged; controlling the eighth circuit breaker to close to supply power to the low-voltage side grid; detecting a phase angle difference between both sides of the sixth circuit breaker; when the phase angle difference between both sides of the sixth circuit breaker is greater than a setting threshold for phase angle difference, the tap-position adjustment switch is adjusted, the step of detecting the phase angle difference between both sides of the sixth circuit breaker is performed again until the phase angle difference is less than or equal to the setting threshold for phase angle difference; and controlling the sixth circuit breaker to close to make the step-down and phase-shifting transformer be connected to the grids.

In S202, Adjust a tap position of the tap-position adjustment switch according to a current power and a target power at a port of the step-down and phase-shifting transformer, as well as a current tap position of the tap-position adjustment switch of the step-down and phase-shifting transformer until the current power at the port of the step-down and phase-shifting transformer reaches the target power after adjustment.

The port power control and balancing control belong to the power flow control of the step-down and phase-shifting transformer, and this step is used for describing the process of port power control. For the first topological structure, a port power refers to a grid terminal (terminal S) of the third winding or a grid terminal (terminal L) of the second winding; for the second topological structure, a port power refers to a grid terminal (terminal S) of the first winding or a grid terminal (terminal L2) of the third winding; and for the third topological structure, a port power refers to a grid terminal (terminal S1) of the third winding or a grid terminal (terminal S2) of the first winding. The current power can be regarded as a power at the port of the step-down and phase-shifting transformer at a current moment, and the target power can be regarded as a power that the port of the step-down and phase-shifting transformer is intended to achieve. A tap position that the tap-position adjustment switch of the step-down and phase-shifting transformer is located at the current moment is referred to as the current tap position. When the current power is greater than or less than the target power, the tap position of the tap-position adjustment switch is adjusted according to a relationship between the current power and the target power, until the current power at the port of the step-down and phase-shifting transformer reaches the target power.

In S203, alternatively, key nodes in the two sides of grids to which the step-down and phase-shifting transformer is connected is selected, and load rate differences between the key nodes are controlled to be less than a setting threshold for load rate difference.

First, the key nodes in the two sides of grids to which the step-down and phase-shifting transformer is connected are selected. For the first topological structure, key nodes refer to one node in the high-voltage side grid and one node in the low-voltage side grid; for the second topological structure, key nodes refer to one node in the high-voltage side grid and one node of the phase-shifting low-voltage side grid; and for the third topological structure, key nodes refer to nodes in the two high-voltage side grids. The step of controlling load rate differences between the key nodes to be less than a setting threshold for load rate difference can be described as: obtaining a first current power and a first rated capacity of a first key point, and a second current power and a second rated capacity of a second key point; determining a first load rate of the first key point according to the first current power and the first rated capacity, and a second load rate of the second key point according to the second current power and the second rated capacity; controlling an absolute value of a difference between the first load rate and the second load rate to be less than the setting threshold for load rate difference.

The above technical solution implements the functions such as the closed-loop control, the port power control, or the balancing control of the step-down and phase-shifting transformer. The power control is realized by adjusting the tap-position adjustment switch, and the balancing control is realized by controlling the load rate difference between two key nodes.

As an alternative embodiment of the embodiments of the present application, it could be described based on the above embodiment that the step-down and phase-shifting transformer adopts the first topological structure, in which the step-down and phase-shifting transformer is connected to the high-voltage side grid via the first circuit breaker and is connected to the low-voltage side grid via the second circuit breaker.

In this embodiment, when adopting the first topological structure, the step-down and phase-shifting transformer is connected to the high-voltage side grid, that is, it is connected to the high-voltage side grid via the first winding, and a circuit breaker that is referred to as the first circuit breaker is disposed between the first winding and the high-voltage side grid. The step-down and phase-shifting transformer is connected to the low-voltage side grid, that is, it is connected to the low-voltage side grid via the second winding, and a circuit breaker that is referred to as the second circuit breaker is disposed between the second winding and the low-voltage side grid.

In an embodiment, the step of performing closed-loop control on the step-down and phase-shifting transformer to make the step-down and phase-shifting transformer be connected to grids can be described and includes:

a1) controlling the first circuit breaker to close, such that the step-down and phase-shifting transformer is charged.

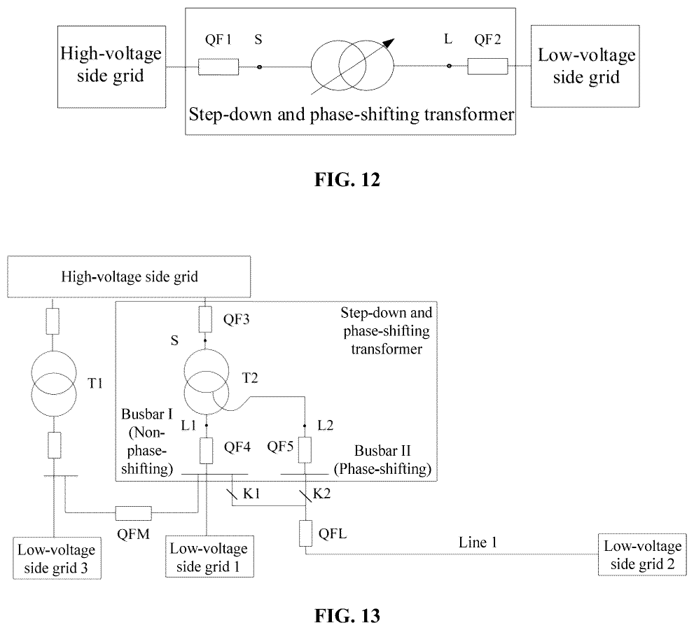

In this embodiment, when the step-down and phase-shifting transformer changes from an exit state to an entering state, in an initial state both the first circuit breaker and the second circuit breaker are in an open position. FIG. 12 is a schematic diagram of the step-down and phase-shifting transformer that adopts the first topological structure to connect to grids provided in this embodiment. As shown in the figure, the first circuit breaker is designated as QF1 and the second circuit breaker is designated as QF2. The circuit breaker QF1 (or QF2) is closed first to charge the step-down and phase-shifting transformer.

b1) a phase angle difference between both sides of the second circuit breaker is detected. When the phase angle difference is greater than a setting threshold for phase angle difference, the tap-position adjustment switch is adjusted, and the step of detecting a phase angle difference between both sides of the second circuit breaker is performed again until the phase angle difference is less than or equal to the setting threshold for phase angle difference.

The setting threshold for phase angle difference can be determined according to actual conditions. In this embodiment, the tap-position adjustment switch of the step-down and phase-shifting transformer is adjusted to make the phase angle difference fall within an acceptable range. When the phase angle difference is greater than the setting threshold for phase angle difference, the tap-position adjustment switch is adjusted, and the step of detecting a phase angle difference between both sides of the second circuit breaker is performed again until the phase angle difference is less than or equal to the setting threshold for phase angle difference. Still referring to FIG. 12, the description is continued based on the above embodiment, a phase angle difference between two sides of the QF2 (or QF1) is detected, and a tap position of the step-down and phase-shifting transformer is adjusted to make the phase angle difference fall within the acceptable range.

Still referring to FIG. 12, the description is continued based on the above embodiment, and the tap-position adjustment switch of the step-down and phase-shifting transformer is adjusted to make the phase angle difference fall within the acceptable range.

d1) the second circuit breaker is controlled to close to enable the step-down and phase-shifting transformer to be connected to the grids.

In this embodiment, still referring to FIG. 12, the description is continued based on the above embodiment, when the phase angle difference between both sides of the second circuit breaker is less than or equal to the setting threshold for phase angle difference, the QF2 (or QF1) is closed, and the step-down and phase-shifting transformer is connected to the high-voltage side grid and the low-voltage side grid, and power control of an interconnection line can be performed. Control of power mutual support between the high-voltage side grid and the low-voltage side grid can be implemented through the tap position adjustment of the step-down and phase-shifting transformer.

The second circuit breaker can also be controlled to close in this step, such that the step-down and phase-shifting transformer is charged, then it is necessary to detect a phase angle difference between both sides of the first circuit breaker, and the phase angle difference is adjusted to be less than the setting threshold for phase angle difference by adjusting the tap-position adjustment switch; and the first circuit breaker is controlled to be closed to make the step-down and phase-shifting transformer be connected to the grids.

The above solution specifies the step of performing closed-loop control on the step-down and phase-shifting transformer to make the step-down and phase-shifting transformer be connected to the grids when the step-down and phase-shifting transformer adopts the first topological structure.

As an alternative embodiment of the embodiments of the present application, it could be described on the basis of the above embodiment that the step-down and phase-shifting transformer adopts the second topological structure, in which the step-down and phase-shifting transformer is connected to the high-voltage side grid via a third circuit breaker, is connected to one low-voltage side grid via a fourth circuit breaker, and is connected to the other low-voltage side grid via a fifth circuit breaker and a second isolating switch in sequence; and the other low-voltage side grid is connected to a first isolating switch and the fourth circuit breaker.

In this embodiment, when adopting the second topological structure, the step-down and phase-shifting transformer is connected to the high-voltage side grid, that is, it is connected to the high-voltage side grid via the first winding, and a circuit breaker that is referred to as the third circuit breaker is disposed between the first winding and the high-voltage side grid. The step-down and phase-shifting transformer is connected to the low-voltage side grid, that is, it is connected to the low-voltage side grid via the second winding, and the second winding has two outgoing lines, which are connected to a non-phase-shifting busbar and a phase-shifting busbar on the low-voltage side, respectively. A circuit breaker that is referred to as the fourth circuit breaker is disposed between one of the outgoing lines of the second winding and the low-voltage side grid. A circuit breaker that is referred to as the fifth circuit breaker is disposed between the other outgoing line of the second winding and the low-voltage side grid.

The step of performing closed-loop control on the step-down and phase-shifting transformer to make the same connected to the grids could be described and includes the followings:

a2) the third circuit breaker is controlled to close, such that the step-down and phase-shifting transformer is charged.

FIG. 13 is a schematic diagram of the step-down and phase-shifting transformer that adopts the second topological structure is connected to grids provided in embodiment two. As shown in FIG. 13, when the step-down and phase-shifting transformer changes from an exit state to an entering state, in an initial state the circuit breakers, i.e., the third circuit breaker (QF3), the fourth circuit breaker (QF4) and the fifth circuit breaker (QF5), are all in an open position, and both the first isolating switch (K1) and the second isolating switch (K2) are in an open position. A Line 1 is powered by a regional power supply of a low-voltage side grid 2. Transformer T1 is running, and a bus tie circuit breaker (QFM) is closed to supply power to a low-voltage side grid 1, in which the bus tie circuit breaker between a low-voltage busbar of the Transformer T1 and a non-phase-shifting busbar of the step-down and phase-shifting transformer is designated as QFM. K1 and K2 are connected to the low-voltage side grid 2 via a main circuit breaker (QFL) which is closed. The circuit breaker QF3 is closed first to charge the step-down and phase-shifting transformer T2.

b2) the fourth circuit breaker is controlled to close to supply power to the low-voltage side grid.

Still referring to FIG. 13, follow to the above description, the circuit breaker QF4 is detected and closed, and the Transformer T1 and the step-down and phase-shifting transformer T2 are operated in parallel for a long period of time or a short period of time (that is, the circuit breaker QFM is closed for operation for a long period of time or a short period of time) to supply power to the low-voltage side grid 1.

c2) the second isolating switch is controlled to close and the first isolating switch is controlled to open.

Still referring to FIG. 13, follow to the above description, K2 is closed, and K1 is in an open position.

d2) a phase angle difference between both sides of the fifth circuit breaker is detected. When the phase angle difference is greater than a setting threshold for phase angle difference, the tap-position adjustment switch is adjusted, and the step of detecting a phase angle difference between both sides of the fifth circuit breaker is performed again until the phase angle difference is less than or equal to the setting threshold for phase angle difference.

Still referring to FIG. 13, a phase angle difference between two sides of the QF5 is detected, and a tap-position of the step-down and phase-shifting transformer is adjusted to make the phase angle difference fall within the acceptable range.

e2) the fifth circuit breaker is controlled to close to complete the connection of the step-down and phase-shifting transformer to the grids.

Still referring to FIG. 13, QF5 is closed, and the Line 1 is powered by a phase-shifting busbar II of the step-down and phase-shifting transformer.

The above solution specifies the step of performing closed-loop control on the step-down and phase-shifting transformer to make the same connected to grids when the step-down and phase-shifting transformer adopts the second topological structure.

As another alternative embodiment of the embodiments of the present application, it could be described on the basis of the above embodiment that the step-down and phase-shifting transformer adopts the third topological structure, in which the step-down and phase-shifting transformer is connected to one high-voltage side grid via a sixth circuit breaker, is connected to the other high-voltage side grid via a seventh circuit breaker, and is connected to a low-voltage side grid via an eighth circuit breaker.

In this embodiment, when the step-down and phase-shifting transformer adopts the third topological structure, that is, it is connected to two high-voltage side grids via two outgoing lines of the first winding. A circuit breaker that is referred to as the sixth circuit breaker is disposed between the first winding and one of the high-voltage side grids. Another circuit breaker that is referred to as the seventh circuit breaker is disposed between the first winding and the other high-voltage side grid. The step-down and phase-shifting transformer is connected to the low-voltage side grid, that is, it is connected to the low-voltage side grid via the second winding, and a circuit breaker that is referred to as the eighth circuit breaker is disposed between the second winding and the low-voltage side grid.

The step of performing closed-loop control on the step-down and phase-shifting transformer to make the same connected to grids includes the followings.

a3) the seventh circuit breaker is controlled to close, such that the step-down and phase-shifting transformer is charged.

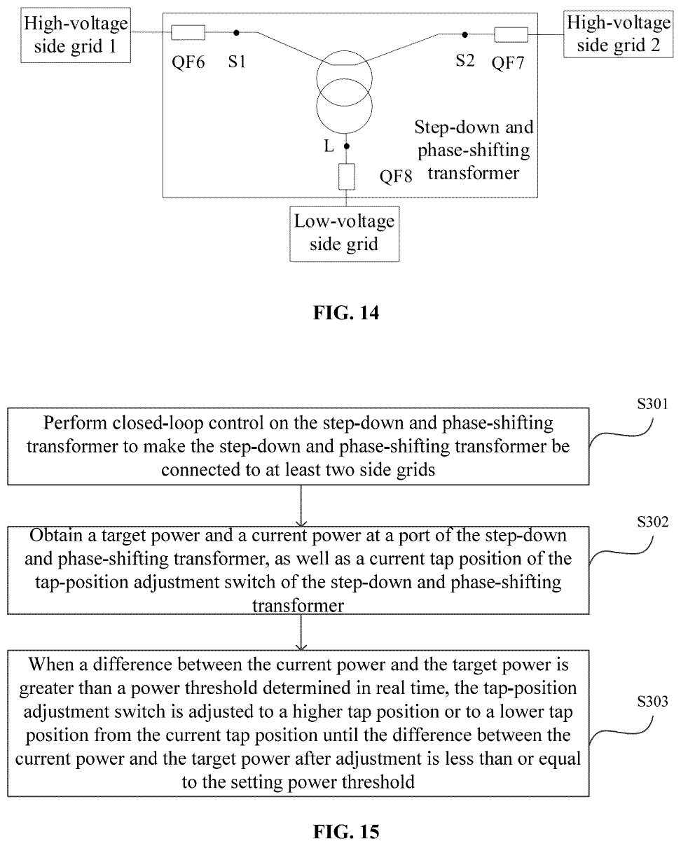

In this embodiment, when the step-down and phase-shifting transformer changes from an exit state to an entering state, the sixth circuit breaker, the seventh circuit breaker and the eighth circuit breaker in an initial state are all in an open position. FIG. 14 is a schematic diagram of the step-down and phase-shifting transformer that adopts the third topological structure is connected to grids provided in this embodiment. As shown in FIG. 14, the sixth circuit breaker is designated as QF6, the seventh circuit breaker is designated as QF7, and the eighth circuit breaker is designated as QF8. The QF7 is closed first to charge the step-down and phase-shifting transformer.

b3) the eighth circuit breaker is controlled to close to supply power to the low-voltage side grid.

Still referring to FIG. 14, follow to the above description. The QF8 is then closed to supply power to the low-voltage side grid.

c3) a phase angle difference between both sides of the sixth circuit breaker is detected. When the phase angle difference between both sides of the sixth circuit breaker is greater than a setting threshold for phase angle difference, the tap-position adjustment switch is adjusted, and the step of detecting a phase angle difference between both sides of the sixth circuit breaker is performed again until the phase angle difference is less than or equal to the setting threshold for phase angle difference.

Still referring to FIG. 14, follow to the above description. The phase angle difference between both sides of QF6 is detected. When the phase angle difference between the two sides of the QF6 is greater than the setting threshold for phase angle difference, a tap-position of the step-down and phase-shifting transformer is adjusted to make the phase angle difference fall within the acceptable range.

d3) the sixth circuit breaker is controlled to close to complete the connection of the step-down and phase-shifting transformer to the grids.

Still referring to FIG. 14, follow to the above description, the QF6 is closed, the step-down and phase-shifting transformer is connected to two high-voltage side grids and one low-voltage side grid, the step-down and phase-shifting transformer can be controlled to control the tap position, such that power exchange between an outlet of the step-down and phase-shifting transformer and one high-voltage side grid falls within a range of setting value.

The above solution specifies the step of performing closed-loop control on the step-down and phase-shifting transformer to make the same connected to grids when the step-down and phase-shifting transformer adopts the third topological structure.

### Embodiment Three

FIG. 15 is a flow chart of an operational control method of a step-down and phase-shifting transformer provided in embodiment three of the present application. In this embodiment, the step of “adjusting a tap position of the tap-position adjustment switch according to a current power at a port of the step-down and phase-shifting transformer and a target power, as well as a current tap position of the tap-position adjustment switch of the step-down and phase-shifting transformer until the current power at the port of the step-down and phase-shifting transformer reaches the target power” is described, and the step of “controlling load rate differences among the key nodes to be less than a setting threshold for load rate difference” is described.

As shown in FIG. 15, the embodiment three provides an operational control method of a step-down and phase-shifting transformer, specifically including the following steps.

In S301, closed-loop control is performed on the step-down and phase-shifting transformer to make the step-down and phase-shifting transformer be connected to at least two side grids.

In S302, a target power and a current power at a port of the step-down and phase-shifting transformer is obtained, as well as a current tap position of the tap-position adjustment switch of the step-down and phase-shifting transformer is obtained.

This step is used for obtaining the target power and the current power at the port of the step-down and phase-shifting transformer, as well as the current tap position of the tap-position adjustment switch of the step-down and phase-shifting transformer.

In S303, when a difference between the current power and the target power is greater than a power threshold determined in real time, the tap-position adjustment switch is adjusted to a higher tap position or to a lower tap position from the current tap position until the difference between the current power and the target power after adjustment is less than or equal to the power threshold determined in real time.

The setting power threshold can be set according to actual conditions. In this embodiment, when the difference between the current power and the target power is greater than the power threshold determined in real time, the tap-position adjustment switch is adjusted to a higher tap position or to a lower tap position from the current tap position until the difference between the current power and the target power after adjustment is less than or equal to the power threshold determined in real time.

In this embodiment, the tap position of the tap-position adjustment switch and the port power of the step-down and phase-shifting transformer constitute a monotonous function. An associated direction can be set that the port power is raised by upshifting the tap position of the tap-position adjustment switch, that is, the port power is raised when upshifting the tap position of the tap-position adjustment switch. Alternatively, an associated direction can also be set that the port power is raised by downshifting the tap position of the tap-position adjustment switch, that is, the port power is raised in the associated direction of downshifting the tap position of the tap-position adjustment switch.

In this embodiment, taking the associated direction that “the port power is raised by upshifting the tap position of the tap-position adjustment switch” as an example for illustration. Illustratively, when the target power is greater than the current power, the tap-position adjustment switch is adjusted to upshift one tap position, and a current power at the output port of the step-down and phase-shifting transformer after adjustment is obtained. Illustratively, assuming that a limit range of the tap position of the step-down and phase-shifting transformer is from −kl to kl, a value at the current tap position is k, a target power value of the port is y, and a current power of the port is y₀. When y>y₀, a tap position of the step-down and phase-shifting transformer is adjusted to k+1, and the current power at that moment is recorded as y₁. When the difference between the current power after adjustment and the target power is less than or equal to the setting power threshold, the tap-position adjustment switch is not adjusted any longer. In this embodiment, when the difference between the current power after adjustment and the target power is less than or equal to the setting power threshold, that is, a difference between an actual power and the target power of the port at that moment is less than a real-time calculated value, it is determined that the adjustment falls within a target value, in which case, the tap-position adjustment switch will not be adjusted any longer.

Follow to the above description, when the difference between the current power after adjustment and the target power is greater than the setting power threshold, the step of adjusting the tap-position adjustment switch to increase by one tap position is performed again until the current power at the port of the step-down and phase-shifting transformer reaches the target power. In this embodiment, for a first adjustment of the tap position, a power threshold used for determining whether the tap position of the step-down and phase-shifting transformer has been adjusted in place is acted as a setting value; for second and subsequent adjustments, a dynamically updated power threshold is used for determining whether the tap position of the step-down and phase-shifting transformer has been adjusted in place, and a calculation method of the dynamically updated power threshold is half of a variable quantity of the previous adjusted power at the port plus an allowable deviation:

$$\vert {y}_{1} - y \vert \leq {α}_{1}$$

$${α}_{1} = \vert {y}_{1} - {y}_{0} \vert / 2 + {ε}_{1}$$

Where α₁ is a power threshold, y is a port target power value, y₀ is a port power before a previous adjustment of the tap position, and y₁ is a port power after the previous adjustment of the tap position (that is, before adjustment of a current tap position); and ε₁ is a setting allowance error which takes account of a sampling error and a difference in an adjustment amount of each tap position.

When the target power is less than the current power, the tap-position adjustment switch is adjusted in an opposite direction, and adjustment principles are the same as above and will not be described herein. In an embodiment, when he associated direction is that the port power is raised by downshifting the tap position of the tap-position adjustment switch, adjustment principles are also the same as above and will not be described herein. When the tap position reaches the limit-kl or kl, the tap-position adjustment switch will not be adjusted any longer; and when the current power of the step-down and phase-shifting transformer changes from a positive deviation from the target value to a negative deviation from the target value, or from the negative deviation from the target value to the positive deviation from the target value, the tap adjustment is stopped.

The above technical solution specifies the step of adjusting a tap position of the tap-position adjustment switch until the current power at the port of the step-down and phase-shifting transformer reaches the target power, thereby achieving port power control of the step-down and phase-shifting transformer.

### Embodiment Four

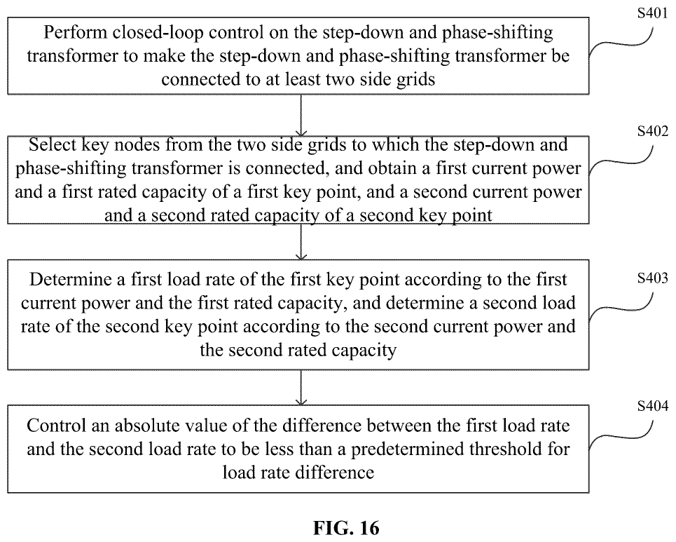

FIG. 16 is a flow chart of an operational control method of a step-down and phase-shifting transformer provided in embodiment four of the present application. In this embodiment, the step of “control load rate differences among the key nodes to be less than a setting threshold for load rate difference” is described.

As shown in FIG. 16, the embodiment four provides an operational control method of a step-down and phase-shifting transformer, which specifically includes the following steps.

In S401, closed-loop control is performed on the step-down and phase-shifting transformer to make the step-down and phase-shifting transformer be connected to at least two side grids.

In S402, key nodes are selected from the two side grids to which the step-down and phase-shifting transformer is connected, and a first current power and a first rated capacity of a first key point, and a second current power and a second rated capacity of a second key point are obtained.

In this embodiment, key nodes are selected from the two side grids of the step-down and phase-shifting transformer. For example, for a step-down and phase-shifting transformer including one high-voltage side and two low-voltage sides, a main transformer on the high-voltage side and a main transformer of an opposite substation connected to the low-voltage phase-shifting busbar can be selected as two key nodes, which are recorded as a first key point and a second key point, respectively. Since the balancing control is to realize automatic control of a load rate difference of two key points falling within a certain range, this step needs to obtain current powers and rated capacities of the first key point and the second key point. The current power of the first key point is recorded as the first current power, and the rated capacity of the first key point is recorded as the first rated capacity. The current power of the second key point is recorded as a second current power, and the rated capacity of the second key point is recorded as a second rated capacity.

In S403, a first load rate of the first key point is determined according to the first current power and the first rated capacity, and a second load rate of the second key point is determined according to the second current power and the second rated capacity.

In this embodiment, the load rate of key node is calculated by dividing the current power by the rated capacity. Specifically, the load rate of the first key point is calculated by dividing the first current power by the first rated capacity. The load rate of the second key point is calculated by dividing the second current power by the second rated capacity.

A calculation formula of the load rate of the key point is expressed as:

$${η}_{1} = \frac{{P}_{i}}{{S}_{iN}} ( i = 1 , 2 ) ,$$

where ηᵢ represents a load rate of an i^{th} key point, pᵢ represents a current power of the i^{th} key point, s_{iN} represents a rated capacity of the i^{th} key point, and i=1,2.

In S404, an absolute value of the difference between the first load rate and the second load rate is controlled to be less than a predetermined threshold for load rate difference.

In this embodiment, the balancing control is to automatically control a load rate difference of two key nodes falling within the certain range, that is, the absolute value of the difference between the first load rate and the second load rate is controlled to be less than the predetermined threshold for load rate difference.

The step for determining the threshold for load rate difference may include:
for a first adjustment of the tap position, a threshold for load rate difference used for determining whether the tap position of the step-down and phase-shifting transformer has been adjusted in place is a setting value; and
for second and subsequent adjustments, a dynamically updated threshold for load rate difference is adopted for determining whether the tap position of the step-down and phase-shifting transformer has been adjusted in place, and a calculation method of the dynamically updated threshold for load rate difference is half of the load rate difference arising from the previous adjustment plus an allowable deviation:

$$\vert \frac{{P}_{1}}{{S}_{1 N}} - \frac{{P}_{2}}{{S}_{2 N}} \vert \leq {α}_{2}$$

$${α}_{2} = \frac{1}{2} * ( \vert \frac{Δ {y}_{1}}{{S}_{1 N}} \vert + \vert \frac{Δ {y}_{2}}{{S}_{2 N}} \vert ) + {ε}_{2}$$

Where, α₂ is a threshold for load rate difference, Δyᵢ represents a power variable quantity of the key point through a previous tap position adjustment of the step-down and phase-shifting transformer, i=1,2; and ε₂ is a setting allowance error which takes account of a sampling error and a difference in an adjustment amount of each tap position.

When the tap position adjustment reaches an upper or lower limit of the tap position of the step-down and phase-shifting transformer, the tap position adjustment is stopped; and when the current power of the step-down and phase-shifting transformer changes from a positive deviation from the target value to a negative deviation from the target value, or from the negative deviation from the target value to the positive deviation from the target value, the tap adjustment is stopped.

The above solution specifies the step of controlling load rate differences among the key nodes to be less than a setting threshold for load rate difference, thereby achieving balancing control of key points of the step-down and phase-shifting transformer.

In order to more clearly describe effects of phase modulation and voltage transformation achieved by the step-down and phase-shifting transformer provided in the embodiments of the present application, simulation results of the three topological structures of the step-down and phase-shifting transformer of the embodiments are described below.

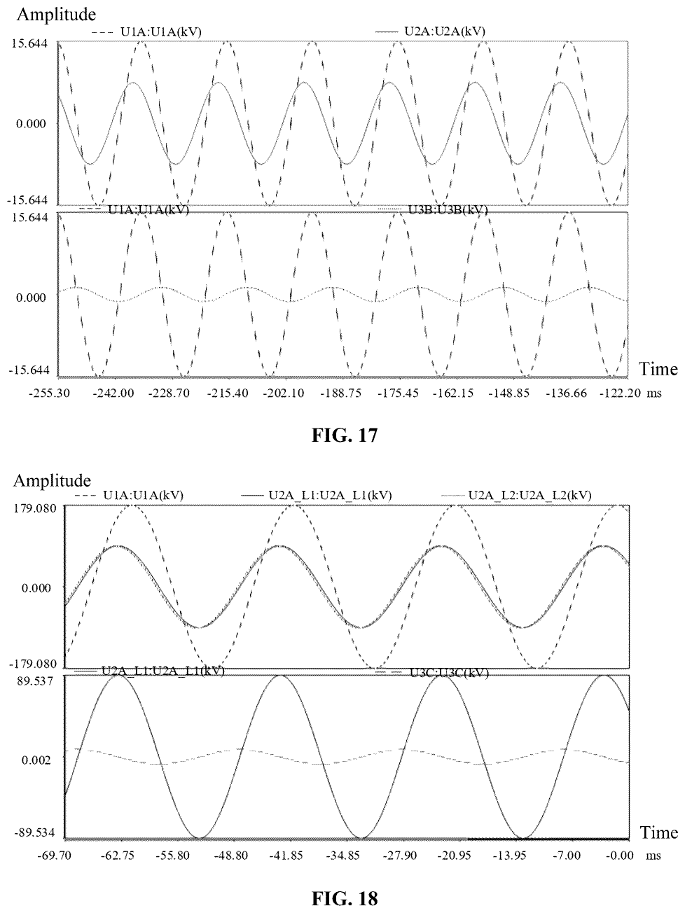

When the step-down and phase-shifting transformer adopts the first topological structure, effects of phase modulation and voltage transformation of the step-down and phase-shifting transformer are simulated. A line voltage on the high-voltage side of the step-down and phase-shifting transformer is 20 kV, and a line voltage on the low-voltage side is 10 kV. In order to achieve a phase adjustment of Φ(Φ=5°), a voltage of the third winding is 1 kV. FIG. 17 is a diagram of simulation effects of the step-down and phase-shifting transformer that adopts the first topological structure to realize step-down and phase-shifting for interconnection with 10 kV and 20 kV power grids. As shown in FIG. 17, the line voltage on the high-voltage side of the step-down and phase-shifting transformer is about 20 kV, the line voltage on the low-voltage side of the step-down and phase-shifting transformer is about 10 kV; and a phase angle of a voltage (U_{3B}) of the third winding differs from a phase angle at a port (U_{1A}) of the first winding on the high-voltage side of the step-down and phase-shifting transformer by a phase angle of 85°. The introduction of the third winding can facilitate the realization of phase angle adjustment. A phase angle of a voltage (U_{2A}) on the low-voltage side leads a phase angle of a voltage (U_{1A}) on the high-voltage side by 35°, thereby achieving the angle adjustment of Φ (Φ=5°).

When the step-down and phase-shifting transformer adopts the second topological structure, effects of phase modulation and voltage transformation of the step-down and phase-shifting transformer are simulated. A line voltage on the high-voltage side of the step-down and phase-shifting transformer is 220 kV, and a line voltage on the low-voltage side is 110 kV. In order to achieve an adjustment of phase Φ (Φ=5°), a voltage of the third winding is 5.5 kV. FIG. 18 is a diagram of simulation effects of the step-down and phase-shifting transformer that adopts a second topological structure to realize step-down and phase-shifting for interconnection with 220 kV and 110 kV power grids. As shown in FIG. 18, the line voltage on the high-voltage side of the step-down and phase-shifting transformer is about 220 kV, the line voltage on the low-voltage side is about 110 kV, and a phase angle of a voltage (U_{3C}) of the third winding differs from a phase angle of a voltage (U_{2A_L1}) at the port L1 of the second winding on the low-voltage side of the step-down and phase-shifting transformer by a phase angle of 90°. The introduction of the third winding can facilitate the realization of phase angle adjustment. A voltage (U_{2A_L2}) at the L2 port on the low-voltage side leads a voltage (U_{2A_L1}) at the L1 port on the low-voltage side by 5°, and leads a voltage (U_{1A}) on the high-voltage side by 35° (an inherent phase angle difference between the high-voltage side grid and the low-voltage side grid is 30°), thereby achieving the angle adjustment of Φ (Φ=5°).

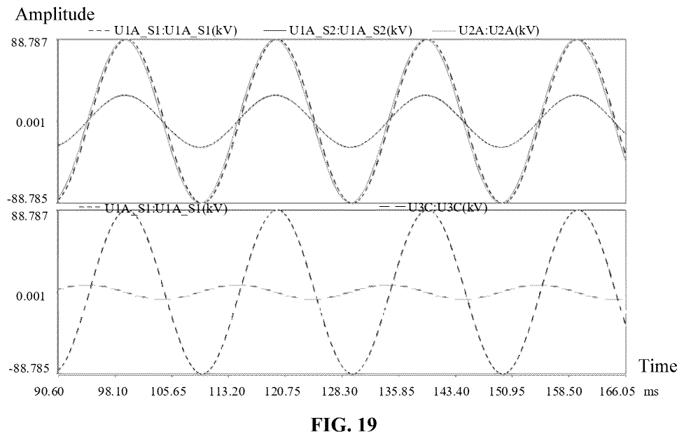

When the step-down and phase-shifting transformer adopts the third topological structure, effects of phase modulation and voltage transformation of the step-down and phase-shifting transformer are simulated. A line voltage on the high-voltage side of the step-down and phase-shifting transformer is 110 kV, and a line voltage on the low-voltage side is 35 kV. In order to achieve a phase adjustment of Φ (Φ=5°), a voltage of the third winding is 5.5 kV. FIG. 19 is a diagram of simulation effects of the step-down and phase-shifting transformer that adopts the third topological structure to realize step-down and phase-shifting for interconnection with 110 kV and 35 kV power grids. As shown in FIG. 19, a line voltage on the high-voltage side of the step-down and phase-shifting transformer is about 110 kV, a line voltage on the low-voltage side is about 35 kV, and a phase angle of a voltage (U_{3C}) of the third winding differs from a phase angle of a voltage (U_{1A_S2}) at the port S2 of the first winding on the high-voltage side of the step-down and phase-shifting transformer by a phase angle of 90°. The introduction of the third winding can facilitate the realization of phase angle adjustment. A voltage (U_{2A}) on the low-voltage side leads a voltage (U_{1A}) on the high-voltage side by 5°, thereby achieving the angle adjustment of Φ (Φ=5°).

Various forms of the above processes can be utilized to reorder, add or deletes the steps. For example, the steps described in the present application can be executed in parallel or sequentially, or in a different order, as long as the desired results of the solution of the present application can be achieved, on which the present application will not impose any restrictions.

What is claimed is:

1. A step-down and phase-shifting transformer, configured to be connected to grids on at least two sides, and at least comprising:
a first winding, a second winding, and a third winding, wherein the first winding, the second winding and the third winding each adopts a three-phase winding; and
the third winding serves as a phase modulation winding and is provided with a tap-position adjustment switch, the third winding is magnetically coupled to the first winding and the second winding, the third winding is electrically connected to the first winding or the second winding, and a phase difference between a voltage of the third winding and a terminal voltage of the first winding or the second winding is 90° or close to 90°, such that on the basis of voltage transformation, phase angle control and transmission power control between grids on different sides can be realized by adjusting the tap-position adjustment switch.

2. The step-down and phase-shifting transformer according to claim 1, wherein the step-down and phase-shifting transformer adopts a first topological structure, the first winding is connected to a high-voltage side grid, and the second winding is connected to a low-voltage side grid;
based on an hour number of the first winding and the third winding, an input terminal of a phase A of the first winding is connected in series with a phase B of the third winding or a phase C of the third winding;
based on the hour number of the first winding and the third winding, an input terminal of a phase B of the first winding is connected in series with the phase C of the third winding or a phase A of the third winding;
based on the hour number of the first winding and the third winding, an input terminal of a phase C of the first winding is connected in series with the phase A of the third winding or the phase B of the third winding; and
the first winding adopts a delta connection, and the second winding adopts a star connection.

3. The step-down and phase-shifting transformer according to claim 1, wherein the step-down and phase-shifting transformer adopts a second topological structure, the first winding is connected to a high-voltage side grid, the second winding has two outgoing lines, a first outgoing line is connected to a non-phase-shifting low-voltage side grid, and a second outgoing line is connected to a phase-shifting low-voltage side grid via the third winding;
based on an hour number of the second winding and the third winding, a second outgoing line of a phase A of the second winding is connected in series with a phase C of the third winding or a phase B of the third winding;
based on the hour number of the second winding and the third winding, a second outgoing line of a phase B of the second winding is connected in series with a phase A of the third winding or the phase C of the third winding;
based on the hour number of the second winding and the third winding, a second outgoing line of a phase C of the second winding is connected in series with the phase B of the third winding or the phase A of the third winding; and
the first winding adopts the star connection, and the second winding adopts the delta connection.

4. The step-down and phase-shifting transformer according to claim 1, wherein the step-down and phase-shifting transformer adopts a third topological structure, the first winding has two outgoing line that are respectively connected to two high-voltage side grids, and the second winding is connected to the low-voltage side grid;
based on an hour number of the first winding and the third winding, an input terminal of a phase A of the first winding is connected in series with a phase C of the third winding or a phase B of the third winding;
based on the hour number of the first winding and the third winding, an input terminal of a phase B of the first winding is connected in series with a phase A of the third winding or the phase C of the third winding;
based on the hour number of the first winding and the third winding, an input terminal of a phase C of the first winding is connected in series with the phase B of the third winding or the phase A of the third winding; and
the first winding adopts the delta connection, and the second winding also adopts the delta connection.

5. The step-down and phase-shifting transformer according to claim 1, wherein the third winding is provided with a polarity reversing switch to realize an adjustment of a phase angle in a phase leading direction or a phase lagging direction.

6. An operational control method of a step-down and phase-shifting transformer, applied to the step-down and phase-shifting transformer according to claim 1, and the method comprising:
performing closed-loop control on the step-down and phase-shifting transformer to make the step-down and phase-shifting transformer be connected to grids on at least two sides;
adjusting a tap position of the tap-position adjustment switch according to a target power and a current power at a port of the step-down and phase-shifting transformer, as well as a current tap position of the tap-position adjustment switch of the step-down and phase-shifting transformer until the current power at the port of the step-down and phase-shifting transformer after adjustment reaches the target power; or
selecting key nodes in the grids on the two sides to which the step-down and phase-shifting transformer is connected, and controlling load rate differences among the key nodes to be less than a setting threshold for load rate difference.

7. The method according to claim 6, wherein when adopting a first topological structure, the step-down and phase-shifting transformer is connected to a high-voltage side grid via a first circuit breaker, and is connected to a low-voltage side grid via a second circuit breaker;
the performing closed-loop control on the step-down and phase-shifting transformer to make the step-down and phase-shifting transformer be connected to grids comprises:
controlling the first circuit breaker to close, such that the step-down and phase-shifting transformer is charged;
detecting a phase angle difference between both sides of the second circuit breaker; and when the phase angle difference is greater than a setting threshold for phase angle difference, adjusting the tap-position adjustment switch, and performing the step of detecting the phase angle difference between both sides of the second circuit breaker again until the phase angle difference is less than or equal to the setting threshold for phase angle difference; and
controlling the second circuit breaker to close to enable the step-down and phase-shifting transformer to be connected to the grids.

8. The method according to claim 6, wherein when adopting a second topological structure, the step-down and phase-shifting transformer is connected to a high-voltage side grid via a third circuit breaker, is connected to one low-voltage side grid via a fourth circuit breaker, and is connected to the other low-voltage side grid via a fifth circuit breaker and a second isolating switch in sequence, and the other low-voltage side grid is connected to a first isolating switch and the fourth circuit breaker;
the performing closed-loop control on the step-down and phase-shifting transformer to make the step-down and phase-shifting transformer be connected to grids comprises:
controlling the third circuit breaker to close, such that the step-down and phase-shifting transformer is charged;
controlling the fourth circuit breaker to close to supply power to the low-voltage side grid;
controlling the second isolating switch to close and the first isolating switch to open;
detecting a phase angle difference between both sides of the fifth circuit breaker; and when the phase angle difference is greater than a setting threshold for phase angle difference, adjusting the tap-position adjustment switch, and performing the step of detecting the phase angle difference between both sides of the fifth circuit breaker again until the phase angle difference is less than or equal to the setting threshold for phase angle difference; and
controlling the fifth circuit breaker to close to complete the connection of the step-down and phase-shifting transformer to the grids.

9. The method according to claim 6, wherein when adopting a third topological structure, the step-down and phase-shifting transformer is connected to one high-voltage side grid via a sixth circuit breaker, is connected to the other high-voltage side grid via a seventh circuit breaker, and is connected to a low-voltage side grid via an eighth circuit breaker;
the performing closed-loop control on the step-down and phase-shifting transformer to make the step-down and phase-shifting transformer be connected to grids comprises:
controlling the seventh circuit breaker to close, such that the step-down and phase-shifting transformer is charged;
controlling the eighth circuit breaker to close to supply power to the low-voltage side grid;
detecting a phase angle difference between both sides of the sixth circuit breaker; and when the phase angle difference between both sides of the sixth circuit breaker is greater than a setting threshold for phase angle difference, adjusting the tap-position adjustment switch, and performing the step of detecting the phase angle difference between both sides of the sixth circuit breaker again until the phase angle difference is less than or equal to the setting threshold for phase angle difference;
controlling the sixth circuit breaker to close to complete the connection of the step-down and phase-shifting transformer to the grids.

10. The method according to claim 6, wherein
for a first topological structure, the target power and the current power at the port of the step-down and phase-shifting transformer are a target power and a current power at a grid terminal of the third winding or a grid terminal of the second winding;
for a second topological structure, the target power and the current power at the port of the step-down and phase-shifting transformer are a target power and a current power at a grid terminal of the first winding or a grid terminal of the third winding; and
for a third topological structure, the target power and the current power at the port of the step-down and phase-shifting transformer are a target power and a current power at a grid terminal of the third winding or a grid terminal of the first winding.

11. The method according to claim 6, wherein
for a first topological structure, the key nodes in the grids on the two sides to which the step-down and phase-shifting transformer is connected are one node of a high-voltage side grid and one node of a low-voltage side grid;
for a second topological structure, the key nodes in the grids on the two sides to which the step-down and phase-shifting transformer is connected are one node in a high-voltage side grid and one node of a phase-shifting low-voltage side grid; and
for a third topological structure, the key nodes in the grids on the two sides to which the step-down and phase-shifting transformer is connected are two nodes of two high-voltage side grids, respectively.

12. The method according to claim 6, wherein the adjusting a tap position of the tap-position adjustment switch according to a target power and a current power at a port of the step-down and phase-shifting transformer, as well as a current tap position of the tap-position adjustment switch of the step-down and phase-shifting transformer until the current power at the port of the step-down and phase-shifting transformer after adjustment reaches the target power comprises:
obtaining the target power and the current power at the port of the step-down and phase-shifting transformer, as well as the current tap position of the tap-position adjustment switch of the step-down and phase-shifting transformer; and
when a difference between the current power and the target power is greater than a setting power threshold, adjusting the tap-position adjustment switch to a higher tap position or to a lower tap position from the current tap position until the difference between the current power and the target power after adjustment is less than or equal to a power threshold determined in real time.

13. The method according to claim 6, wherein the controlling load rate differences among the key nodes to be less than a setting threshold for load rate difference comprises:
obtaining a first current power and a first rated capacity of a first key point, and a second current power and a second rated capacity of a second key point;
determining a first load rate of the first key point according to the first current power and the first rated capacity, and a second load rate of the second key point according to the second current power and the second rated capacity; and
controlling an absolute value of a difference between the first load rate and the second load rate to be less than a predetermined threshold for load rate difference.

14. The method according to claim 12, wherein a step for determining the power threshold comprises:
for a first adjustment of the tap position, using a setting value as a power threshold for determining whether the tap position of the step-down and phase-shifting transformer has been adjusted in place; and
for second and subsequent adjustments, using a dynamically updated power threshold for determining whether the tap position of the step-down and phase-shifting transformer has been adjusted in place, wherein a calculation formula of the dynamically updated power threshold is expressed as:
$${α}_{1} = \vert {y}_{1} - {y}_{0} \vert / 2 + {ε}_{1}$$
wherein, α₁ is a power threshold, y₀ is a port power before a previous adjustment of the tap position, and y₁ is a port power after the previous adjustment of the tap position; and ε₁ is an allowance error that is set on the basis of considering a sampling error and a difference in an adjustment amount of each tap position.

15. The method according to claim 13, wherein a step for determining the threshold for load rate difference comprises:
for a first adjustment of the tap position, using a setting value as a threshold for load rate difference for determining whether the tap position of the step-down and phase-shifting transformer has been adjusted in place; and
for second and subsequent adjustments, using a dynamically updated threshold for load rate difference for determining whether the tap position of the step-down and phase-shifting transformer has been adjusted in place, wherein a calculation formula of the dynamically updated threshold for load rate difference is expressed as:
$${α}_{2} = \frac{1}{2} * ( \vert \frac{Δ {y}_{1}}{{S}_{1 N}} \vert + \vert \frac{Δ {y}_{2}}{{S}_{2 N}} \vert ) + {ε}_{2}$$
wherein, α₂ is a threshold for load rate difference, and S_{iN} represents a rated capacity of an i^{th} key point, i=1,2; Δyᵢ represents a power variable quantity of the key point through a previous tap position adjustment of the step-down and phase-shifting transformer, i=1,2; and ε₂ is an allowance error that is set on the basis of considering a sampling error and a difference in an adjustment amount of each tap position.

16. The method according to claim 12, wherein when a tap position adjustment reaches an upper or lower limit of the tap position of the step-down and phase-shifting transformer, the tap position adjustment is stopped; and when the current power of the step-down and phase-shifting transformer changes from a positive deviation from a target value to a negative deviation from the target value, or from a negative deviation from a target value to a positive deviation from the target value, the tap position adjustment is stopped.

17. The method according to claim 13, wherein when a tap position adjustment reaches an upper or lower limit of the tap position of the step-down and phase-shifting transformer, the tap position adjustment is stopped; and when the current power of the step-down and phase-shifting transformer changes from a positive deviation from a target value to a negative deviation from the target value, or from a negative deviation from a target value to a positive deviation from the target value, the tap position adjustment is stopped.
